(19) United States
(12) Patent Application Publication
(10) Pub. No.: US 2003/0130882 A1
(43) Pub. Date: Jul. 10, 2003

(54) System and method for synchronous peer-to-peer appointment scheduling facilitation

(76) Inventors: Saxon Shuttleworth, Vancouver (CA); Rebecca Chan, Vancouver (CA); Julka Trajic, Burnaby (CA); Henricus Gerardus Spaay, North Vancouver (CA)

Correspondence Address: Robert E. Krebs, BURNS, DOANE, SWECKER & MATHIS, L.L.P., P.O. Box 1404, Alexandria, VA, 22313-1404, US

(21) Appl. No.: 10/113,874

(22) Filed: Mar. 27, 2002

Related U.S. Application Data
(60) Provisional application No. 60/347,315, filed on Jan. 9, 2002.

(51) Int. Cl. G06F 17/60

(52) U.S. Cl. 705/8

(57) ABSTRACT

In accordance with the present invention there is provided a method for serverless calendar sharing that allows free/busy time to be exchanged, viewed and new appointments scheduled between computing devices sharing a common calendar format without the use of a server and using a peer-to-peer network. An interval for the meeting/appointment is selected by an initiating device, and a request is sent out to participant devices in the peer-to-peer network for a set of free and busy time slots. A time slot for a meeting is considered free if it is correspondingly free in all participating responses, otherwise it is busy. The aggregate busy time is resolved using an efficient algorithm that is easily computed on low-compute-power devices such as handhelds.

### RELATED APPLICATION

The present application claims priority under 35 U.S.C. § 119 to U.S. Provisional Patent Application No. 60/347,315 entitled SYSTEM AND METHOD FOR SYNCHRONOUS PEER-TO-PEER APPOINTMENT SCHEDULING FACILITATION filed on Jan. 9, 2002, the entire contents of which is hereby incorporated by reference.

### BACKGROUND OF THE INVENTION

The present invention generally relates to the process of calendaring events and more particularly to a system and method that allows shared scheduling and calendar reconciliation between computing devices without the use of a server. This is of particular value when using mobile and/or handheld computing devices (also referred to as portable computing devices).

With the popularity of portable computing devices (i.e., PDAs, Cell Phones, etc.) increasing, there is becoming a greater need and ability to share information between devices. Computing networks can be established between the devices so that collaborative information can be exchanged and shared. The portable computing devices are capable of forming computing networks with or without a central server in order to share and exchange information in a seamless manner.

In addition to the aforementioned use of portable computing devices to transfer and share information, the computing devices are also used in the traditional role of storing personal information. The portable device can store contact, calendar and appointment information for the user. The information can be transferred to other portablecomputing devices over a computing network established by the computing devices.

Efficient scheduling of appointments and meetings between several people is a constant need in both personal and professional contexts. Portable computing devices can function as computerized Personal Information Manager (PIM) systems that provide calendars that can be shared through the use of a network. Typically, a central server is used for the sharing of calendaring and scheduling information between computing devices. The central server manages and resolves appointment requests and reconciliation between the calendars of the users. The network is either through a workgroup's local area network (LAN) or through the Internet with the use of a Web-based application. This requires the user to both be connected to the appropriate network and have access to the appropriate server.

However, often the need for shared scheduling and calendar reconciliation occurs in situations where access to the central server is not possible and/or where bandwidth is low. These situations occur when the user is mobile and out of networking range with the central server. The users of portable computing devices outside the range of a central server do not have an easy way of sharing and visualizing schedules to find common free time and schedule a subsequent meeting between all of them without individually inspecting each calendar view on each device and verbally negotiating appropriate times.

The present invention addresses the above-mentioned deficiencies in scheduling and calendaring meetings with portable computing devices by providing a serverless calendar sharing system that facilitates appointment reconciliation between computing devices having the same collaborative scheduling software. The present invention provides shared views of individual and composite free and busy times between the users of mobile devices without the use of a central server. Furthermore, the present invention supports peer-to-peer connections and communications to enable shared appointment scheduling and concurrent automatic calendar updates on all mobile computing devices. Additionally, the present invention enables appointment reconciliation on a variety of devices including those with limited memory and low computing power.

### BRIEF SUMMARY OF THE INVENTION

In accordance with the present invention there is provided a method for serverless calendar sharing that allows free/busy time to be exchanged, viewed and new appointments scheduled between computing devices sharing a common calendar format without the use of a server and using a peer-to-peer network. An interval for the meeting/appointment is selected by an initiating device, and a request is sent out in parallel to participant devices in the peer-to-peer network for a set of free and busy time slots. A time slot for a meeting is considered free if it is correspondingly free in all participating responses, otherwise it is busy. The aggregate busy time is resolved using an efficient algorithm that is easily computed on low-compute-power devices such as mobile handhelds.

With the present invention, the user can view the resulting free and busy times in several different presentations, choose a slot for the meeting, and send a meeting request back to all participants. Their responses received from the other participants in the peer-to-peer network can indicate whether they accept, deny, or tentatively accept the meeting. The initiating user can then schedule the meeting which will then be updated on all the participants' devices through the peer-to-peer network. Alternatively, individual participants do not need to accept the meeting date and can cancel it.

### BRIEF DESCRIPTION OF THE DRAWINGS

These as well as other features of the present invention will become more apparent upon reference to the drawings wherein:

FIG. 1 is a diagram illustrating mobile computing devices in a peer-to-peer network;

FIG. 2 is a flowchart showing how an appointment is scheduled between users of the mobile devices shown in FIG. 1;

FIGS. 3-13 are screenshots illustrating operation of software utilizing the present invention;

FIG. 14 are screenshots illustrating the present invention when the initiator is not connected to partners;

FIG. 15 are screenshots illustrating the connection process; and

FIG. 16 are screenshots illustrating the appointment booking process.

### DETAILED DESCRIPTION OF THE INVENTION

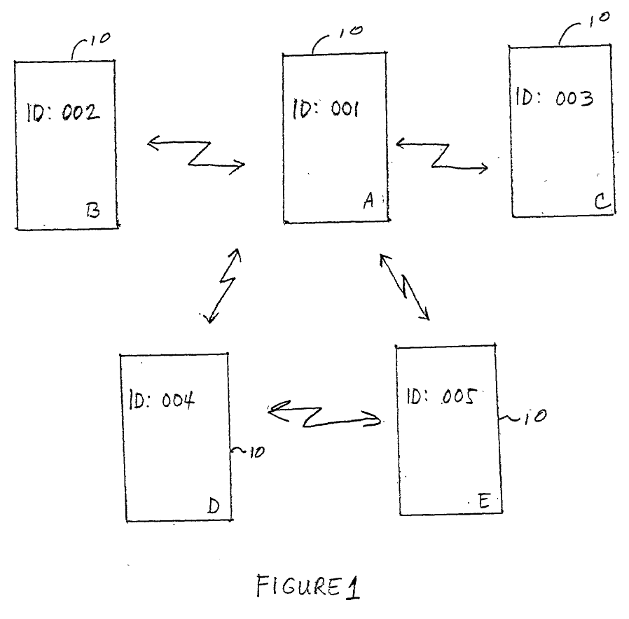

Referring now to the drawings wherein the showings are for purposes of illustrating a preferred embodiment of the present invention only, and not for purposes of limiting the same, FIG. 1 illustrates portable computing devices 10 in a peer-to-peer network. The computing devices can be portable devices such as Personal Digital Assistants (PDA's), cell phones, or laptop computers. The devices 10 communicate to one another over a peer-to-peer network that can be wired or wireless, but does not include the use of a central server which stores calendaring information for the devices. For example, the devices can communicate via a Bluetooth connection; however, the type of network can be generic. Referring to FIG. 1, for the present application, each of the computing devices 10 is identified with a letter (i.e., Devices A, B, C, D, and E).

As previously discussed above, typically, users of computing devices will utilize the services of a central server to coordinate scheduling of appointments. However, in the networking arrangement shown in FIG. 1, none of the computing devices 10 is a central server such that the computing devices are configured in a peer-to-peer network. Accordingly, not one of the devices 10 stores central calendaring information for all people, such that it is not possible to schedule a meeting time between the devices' owners.

The collaborative scheduling software of the present invention provides a simple stand-alone application that enables a group of users to share their free/busy time schedules with one another to select and schedule appointments or meetings without the use of a central server. The collaborative scheduling software is resident on all of the devices A, B, C, D, and E that are in the network. In the current embodiment, the collaborative scheduling software can connect up to 8 partners/participants in a Bluetooth piconet order to share calendaring information. However, the algorithm is not limited to 8 partners/participants and the number of partners/participants could be more or less depending on the type of network. The software allows participants to view a list of available meeting times and graphically view mutual availability, as will be further explained below. Furthermore, the software allows quick and easy appointment scheduling with connected participants, as well as quick resolution of appointment conflicts.

In order to begin the collaborative scheduling, the user of an initiator device A (i.e. an initiator) will specify timing criteria for the meeting (i.e., a period of time in which A prefers that the meeting take place), as seen in step 100. Specifically, the user of device A will specify a range of dates or time (interval) for the meeting, as well as the desired duration. As is evident, the user of the initiator device A does not know convenient times to schedule the appointment because computing device A does not store scheduling information of the other devices. Therefore, according to the present invention, the user of device A must send out a request for intervals of free/busy time to the other devices.

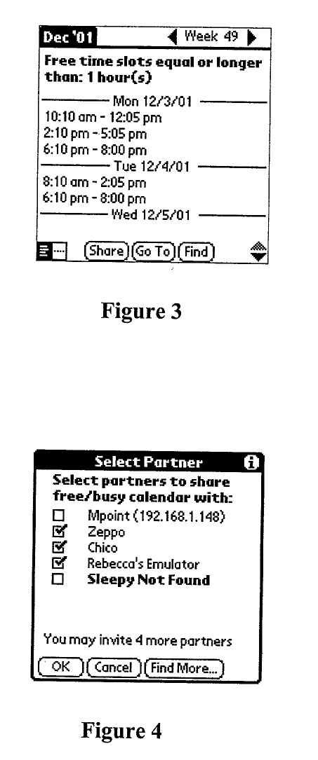

As seen in FIG. 3, the collaborative scheduling software can present the free time slots that are available for meetings to the user of initiator device A. The software accesses the calendar database of the portable device and presents times that are free. The software has the ability to find available times for the user during future days and weeks, or to find an available block of time having a minimum desired duration (i.e., 1 hour).

Once the meeting period has been decided, the initiator will contact the other portable devices whose users are to be partners in the meeting, as seen in step 102. In this respect, as seen in FIG. 1, the initiator device A will contact partner devices B, C, D, and E whose users are to be participants (i.e., partners in the meeting/appointment). Each of the devices for partners B, C, D, and E, as well as initiator device A, contain the same collaborative scheduling software. In this respect, the collaborative scheduling software resident in each device 10 is capable of accessing the calendar database stored within the device 10 in order to determine calendaring information for a respective user. In order to contact the partners, the user of initiator device A will tap on the “Share” or similarly titled button shown in FIG. 3. This will present the initiator with a cached list of recent partners. If the desired partners are not in the cached list the initiator can initiate the appropriate discovery process in order to find the partners who are within range. For example, if the devices 10 are utilizing a Bluetooth piconet, then by tapping the “Share” button, the Bluetooth discovery process will commence.

Referring to FIG. 4, the list of partners is displayed when the discovery process has completed. For example, in FIG. 1, the discovered partners would be devices B, C, D and E. The list of partners are those participants who are within range of the initiator device A. The list may also include partners who have previously established a session, yet were not discovered. If a partner from a previous session is not discovered, it will be noted by their name, as seen in FIG. 4. The software also enables an initiator to find more partners in an area by selecting the “Find More . . .” or a similarly titled button.

By selecting partners (for example, by selecting check boxes next to a partners name), the initiator can choose whom they wish to share calendaring information. Once the initiator has selected the appropriate partners, then an availability request with the meeting criteria is sent. Accordingly, in step 104, the initiator device A will send a request for intervals of free/busy time that match the criteria specified by the initiator device A.

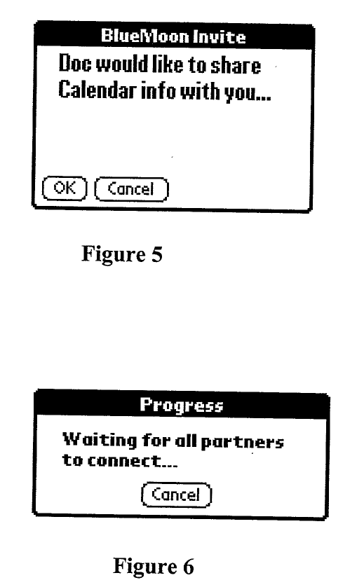

If a discovered partner does not have the collaborative scheduling software, then a message will be presented to the initiator indicating that the required software is not installed on the desired partner. If the desired partner does have the collaborative scheduling software, then the partner will be given the option of whether to share calendar information with the initiator. Referring to FIG. 5, a message telling the partner that the initiator would like to share calendar information is presented to the partner. At this point, the partner can begin the sharing process by selecting “OK” or cease the process by selecting “Cancel”, or a similarly titled button.

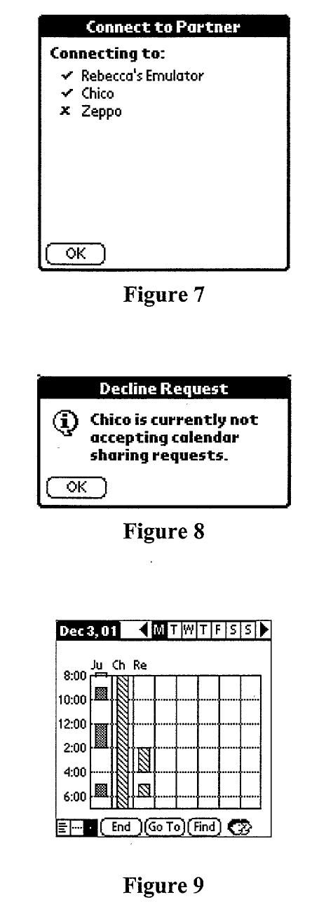

If the partner agrees to share calendar information, then a connection is established and an availability request is sent to the partner, as described in step 104. The progress is displayed on the partner's device as seen in FIG. 6. Furthermore, on the initiator's device, the collaborative scheduling software indicates the connection progress with the partners, as seen in FIG. 7. If the initiator successfully connects to a partner, then a check mark is indicated next to that partner's name. However, if a connection is not established, then an “X” or similar indicator is placed next to the partner's name. Furthermore, if a partner declines to share calendaring information, then the collaborative scheduling software will present a dialog box indicating such, as seen in FIG. 8. Once all of the connections have been established, the initiator needs to select the “OK” or similarly titled button in order to continue the scheduling process.

In response to the calendaring request, in step 106, each of the partners respond to the initiator device A, with information containing free/busy time intervals that match the criteria specified by the initiator device A. Specifically, the collaborative scheduling software resident on each device 10 will read the calendar database on the device. The collaborative scheduling software will then compress the interval of free/busy time information into a run-length encoded representation for efficiency. In the current embodiment, the run-length encoding used is a bitwise representation. For instance, the interval in question (i.e., the time and date matching the meeting criteria from the initiator) from the initiator is divided into 5 minute slots wherein each slot will contain a “1” indicating a busy status and a “0” indicating a free status. This representation can then be efficiently compressed (using run-length encoding for example). The busy status indicates that the calendar database resident on that device shows that there is a meeting already scheduled during that five minute interval. Conversely, the free status indicates that no meeting is scheduled during that five minute interval. The vector of bitwise information is then transmitted to the initiator device A. It will be recognized that the compression of the interval of free/busy time allows for efficient transmission of this information. It will be further recognized that different methods for run-length encoding are possible. However, it is possible to transfer the information without compression, if desired.

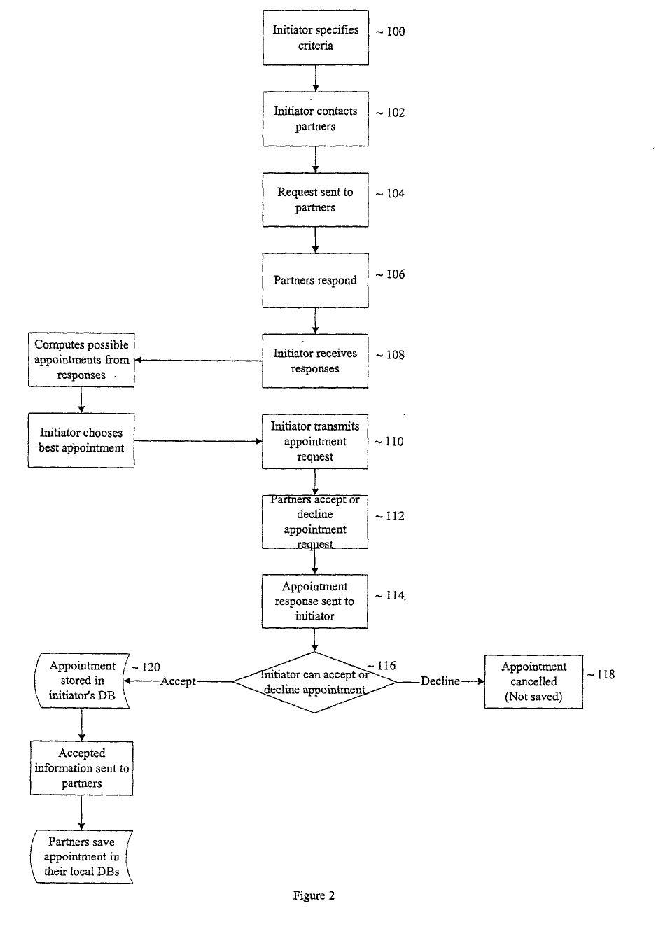

Referring to step 108 of FIG. 2, the initiator device A receives the vectors of bitwise information (i.e., responses) from the partner devices B, C, D, and E. The collaborative scheduling software on the initiator device A will perform a bitwise AND operation on the set to derive a composite single vector showing all free and busy slots over the entire participant group. Next, the collaborative software of the initiator device A maps the 5-minute slots onto larger hour slots and presents the aggregate and individual free time intervals for the initiator and all partners. Typically, this information is presented on the computing device A by various graphical and textual representations, such as by table and list formats. Referring to FIG. 9, the display on the initiator's device A can show the free/busy time for each of the partners as a bar graph, such that a mutually agreeable time for the meeting can be found.

Once the information has been presented on the initiator device A, the initiator can choose a suitable meeting/appointment time based upon the information presented. In step 110, once the user of initiator device A has chosen a suitable time, an appointment request is then sent to the partner devices B, C, D, and E. The appointment request is chosen by the user of the initiator device A and may or may not correspond to the free time intervals computed. In this sense, it is possible for the user of initiator device A to pick an appointment request which may be convenient to only certain partners but not all of them. The initiator has the freedom to determine the most convenient appointment time even though that might not be a free time for all of the partners.

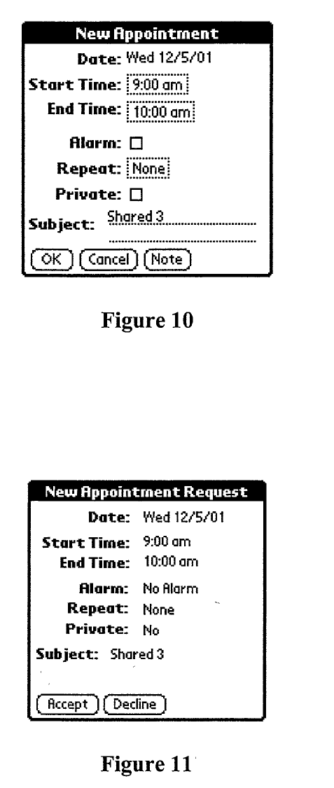

Referring to FIG. 10, the initiator can schedule a new appointment which will be shared with the partners connected to the initiator. If the initiator accepts the new appointment, it will be sent to all connected partners over the network.

After the appointment request has been transmitted by the initiator device A, the requests are received by the partner devices B, C, D, and E. In step 112, the collaborative scheduling software allows the partners to either accept, decline, or tentatively accept the appointment. Referring to FIG. 11, the new appointment information is presented to the partner for acceptance.

In step 114, the partner can either accept or decline the invitation. If the partner accepts the new appointment, then an accept response is sent to the initiator. If the partner declines the invitation, then a decline response is sent to the initiator. If the partner does not do anything (i.e., neither accepts or declines), then the appointment/meeting is not added to the partner's calendar database and a timeout response is sent to the initiator.

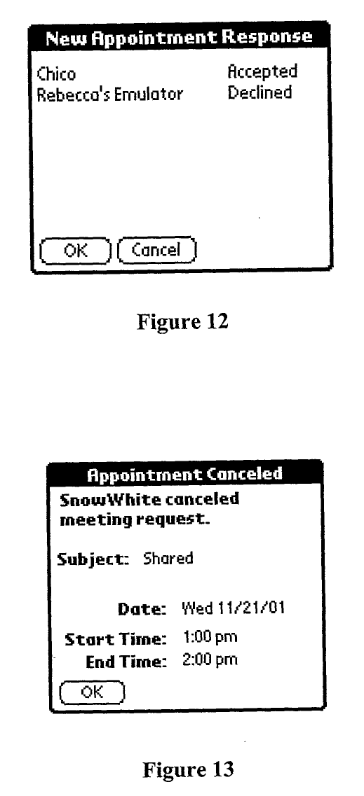

Once the acceptance/decline information transmitted by the partners is received by the initiator device A, the collaborative scheduling software will present to the initiator which partners have accepted or declined the appointment. This can be accomplished by showing the initiator the number of partners who accepted, tentatively accept, or declined, or by listing individual partner responses so that the initiator can determine the individual responses, as seen in FIG. 12.

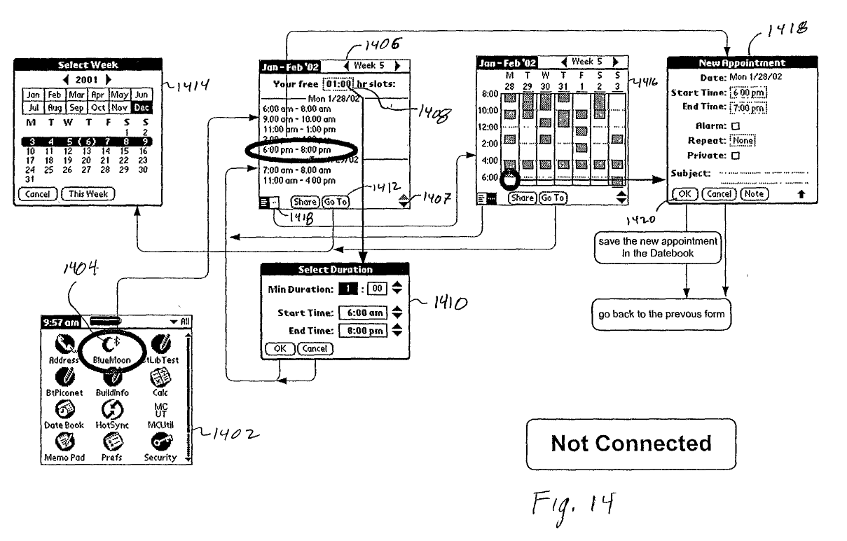

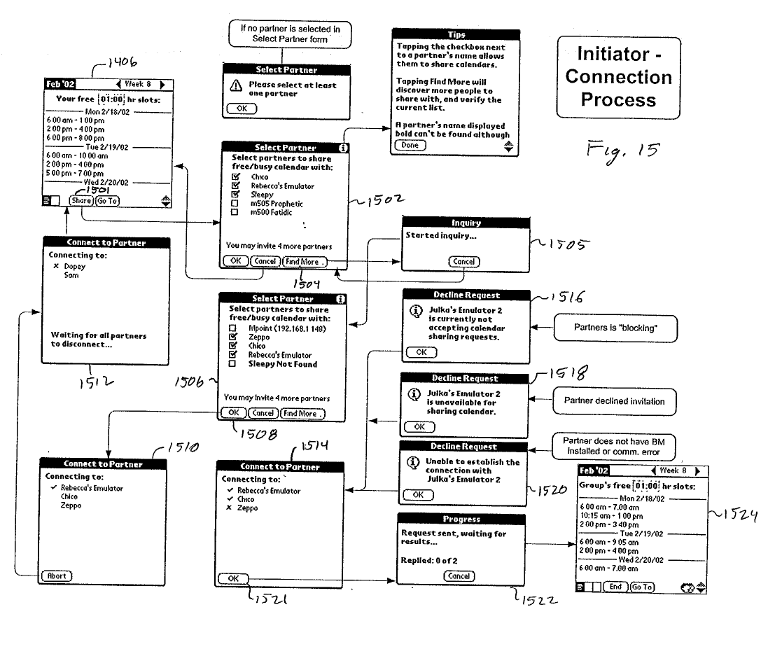

Based upon the participant responses, the initiator can either accept or decline the appointment, as seen in step 116. For instance, if the initiator determines that enough partners do not wish to meet at the proposed time, then in step 118, the initiator can send out an appointment cancellation notification to the partners' devices (i.e., devices B, C, D, and E), as seen in FIG. 13. However, if the initiator determines that the responses received from the partners is adequate, then the initiator will accept and the appointment will be stored in the calendar database of the initiator's device A, as seen in step 120 and the appointment will be sent to each accepted partner and automatically stored in the calendar database on the partner's device. As such the initiator has final control over the scheduling process.

Referring to FIG. 14, the process of entering an appointment with the software of the present invention is shown. As will be recognized by those of ordinary skill in the art, the screenshots in FIGS. 14-16 are illustrative of the display initiators and partners might view using the software of the present invention and therefore depict a series of events. However, the screenshots are only representative of one embodiment of the present invention such that other representations may be displayed on the user's device. Screenshot 1402 shows the display of a portable device such as a PDA wherein the user can initiate the software of the present invention. When the user selects icon 1404, the software of the present invention will display screenshot 1406 which displays the user's available appointment time slots for designated days. The user can scroll through available appointment slots with scroll icon 1407. By selecting the duration time icon 1408, the user can vary the duration of the appointments with screenshot 1410. This enables the user to select the duration of free appointments, as well as schedule the start and ending times of free appointments to be displayed.

By selecting the “Go To” icon 1412, the user can choose a specific month and week for free time to be displayed, as seen in screen shot 1414. This allows the user to display free appointment times in the future. Additionally, the user can choose free appointment times with the graphical display shown in screen shot 1416. Specifically, if the user selects icon 1418, then the software of the present invention will display screenshot 1416 wherein the user can view free appointment times graphically. The free appointment times are displayed as non-shaded areas of the calendar display.

The user has two options in scheduling a new appointment. The first option is for the user to select the free appointment time by selecting the time of the appointment in screenshot 1406. Alternatively, the user can schedule the new appointment graphically by selecting the time of the appointment in the non-shaded area of screenshot 1416. In either instance, once the user has selected the time of the new appointment, the software of the present invention will display new appointment screen 1418 which allows the user to choose the specifics of the appointment. For instance, when the new appointment screen 1418 is displayed, the software of the present invention will automatically insert the date, start time and end time of the appointment. With new appointment screen 1418, the user will be able to include other details such as initiating an alarm when the appointment occurs, repeating the appointment, or making the appointment private such that it cannot be displayed on the devices of other users. Furthermore, the user can include the subject of the appointment with new appointment screen 1418.

The user can approve the appointment by selecting the “OK” icon which saves the appointment in the datebook of the electronic device. Alternatively, the user can cancel the appointment.

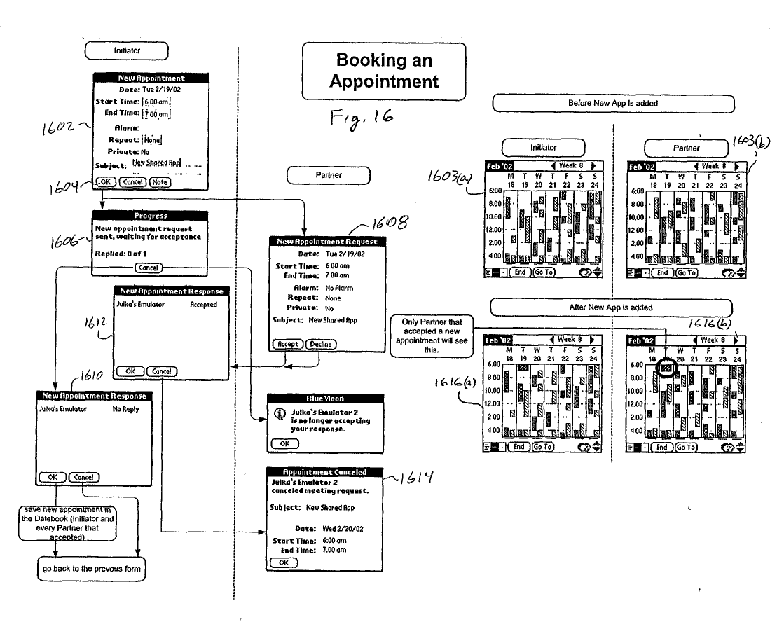

Referring to FIG. 15, the connection process between an initiator and partners according to the present invention is shown. Screen shot 1402 illustrates the available appointment slots that the initiator can schedule with partners, as previously described. By selecting the “Share” icon 1501, the initiator can send his or her free appointment times to desired partners. Referring to screenshot 1502, the initiator can select the partners to share his or her calendar. By selecting the box next to a partner's name, the initiator can choose the partner to share calendar information. As previously discussed, the list of partners in screenshot 1502 are partners that were previously selected by the initiator. By selecting the “Find More” icon 1504, the portable device of the initiator can search for other partner's in the area of the initiator. For example, the BlueTooth discovery process will initiate in order to inquire other devices in the area (screenshot 1505). As seen in screenshot 1506, the partners screen will be updated with new partners and partners not present will be displayed as such.

Once the initiator has selected the desired partners to share schedules, the initiator can select the “OK” icon 1508 in order to share schedules. As the connection process commences, screenshot 1510 is displayed to show the connection process and allow the initiator to abort the process. If the connection process is aborted by the initiator, then screenshot 1512 is displayed showing that the connections with the partners are being disconnected. On the other hand, if the initiator allows the connection process to commence, screenshot 1514 will show which partners have or have not established a connection. Furthermore, if the software of the present invention is not able to establish a connection because a partner is blocking the connection (screenshot 1516), the partner declines the invitation to share information (screenshot 1518), or the partner does not have the software of the present invention installed (screenshot 1520), the appropriate message will displayed to the initiator. Once all the connections have been displayed with screenshot 1514, the initiator can proceed with the sharing of calendaring information by selecting the “OK” icon 1521. Next, a progress screenshot 1522 will be displayed showing the results of the sharing calendaring information. Once the connections between the initiator and the partner's have been completed, then screenshot 1524 will be displayed on the electronic device of the initiator showing the mutually agreeable free time between the initiator and partners.

Referring to FIG. 16, the process for booking the appointment between the initiator and partners is shown. Even though FIG. 16 shows the process between the initiator and a single partner, it is possible to book appointments with multiple partners using the same method. The initiator chooses the appropriate time of the appointment with screenshot 1602. As previously discussed, the appointment time may be chosen from screenshot 1522 which displays mutually agreeable free time or the initiator may choose another time convenient to him or her. Screenshots 1603(a) and 1603(b) show the initiator and partners' calendars before the appointment is scheduled. When the initiator accepts the appointment by selecting the “OK” icon 1604, the appointment is transmitted to the connected partners selected. Screenshot 1606 is displayed on the initiator's electronic device showing the progress of the appointment request. If the initiator cancels the appointment scheduling operation in screenshot 1606, then screenshot 1610 is displayed allowing the initiator to save the new appointment in the datebook for all of the partner's that accepted the appointment before the operation was canceled.

During the process of requesting the appointment, screenshot 1608 is displayed on the partner's device showing the appointment information. The partner can either accept or decline the new appointment by selecting the appropriate icon. If the partner accepts the appointment, then the initiator is notified with screenshot 1612. At that point, the initiator can either accept the appointment or cancel the appointment. If the appointment is canceled, then the partner is notified that the initiator did not accept the appointment and the appointment is canceled in the datebook of the partner (screenshot 1614). On the other hand, if the appointment is accepted by the initiator, the appointment is saved in the datebook of the initiator and the partner as seen in screenshots 1616(a) and 1616(b) thereby concluding the appointment scheduling.

Additional modifications and improvements of the present invention may also be apparent to those of ordinary skill in the art such as increasing the number of partners or using a different type of peer-to-peer network. Additionally, the present invention may also function over wired networks using desktop computing devices. As such, it is possible to use the present invention over any type of network (i.e. wireless or wired) and any type of computing device. Thus the particular combination of parts described and illustrated herein is intended to represent only certain embodiments of the present invention, and is not intended to serve as limitations of alternative devices within the spirit and scope of the invention.

1. A method for scheduling an appointment between a first computing device and a second computing device without the use of a server, the method comprising the steps of:
a) determining a time interval for the appointment;
b) sending the time interval from the first computing device to the second computing device;
c) sending from the second computing device a response containing a time schedule of the second computing device within the time interval to the first computing device;
d) comparing the time schedule of the second computing device to a time schedule of the first computing device;
e) determining with the first computing device a time for the appointment based upon the comparison of the time schedules between the first computing device and the second computing device; and
f) agreeing between the first computing device and the second computing device the time for the appointment.

2. The method of claim 1 wherein step (c) comprises sending a time schedule which indicates free and busy time.

3. The method of claim 2 wherein the time schedule indicates free and busy time segregated into prescribed periods of time.

4. The method of claim 3 wherein the prescribed period of time is five minutes.

5. The method of claim 2 wherein in step (d) the time schedule of the first computing device indicates free and busy time.

6. The method of claim 2 wherein step (c) comprises run-length encoding the time schedule.

7. The method of claim 6 wherein the free and busy time is represented by a series of bits.

8. The method of claim 6 wherein step (d) comprises bitwise ANDING the time schedule of the first computing device and the time schedule of the second computing device in order to compare the schedules.

9. The method of claim 8 wherein step (d) further comprises generating on the first computing device a display which indicates the free and busy time of both devices.

10. The method of claim 1 wherein step (c) comprises sending a time schedule read from a calendar database of the second computing device.

11. The method of claim 1 wherein step (d) comprises comparing the time schedule of the second computing device to a time schedule of the first computing device read from a calendar database of the first computing device.

12. The method of claim 1 wherein step (f) comprises agreeing on the time of the appointment by:
i) sending the time of the appointment from the first computing device to the second computing device;
ii) sending an acceptance response from the second computing device to the first computing device if the appointment time is adequate; and
iii) sending a decline response from the second computing device to the first computing device if the appointment time is inadequate.

13. The method of claim 1 wherein the computing devices communicate over a wireless network or wired network.

14. The method of claim 1 wherein the computing devices are handheld computing devices or desktop computing devices.

15. The method of claim 14 wherein the handheld computing devices are selected from the group consisting of:
PDA's;
Cell Phones; and
Laptop Computers.

16. A method for scheduling an appointment between a plurality of handheld computing devices without the use of a server wherein one of the devices is designated an initiator of the scheduling, the method comprising the steps of:
a) determining a time interval for the appointment with the initiator;
b) sending the time interval from the initiator to the other devices;
c) sending a response from the devices to the initiator, each of the responses containing a time schedule of a respective device within the time interval determined by the initiator;
d) comparing with the initiator the time schedules from the devices;
e) determining with the initiator a time for the appointment based upon the comparison of the time schedules of the devices; and
f) agreeing between the initiator and the other devices the time for the appointment.

17. The method of claim 16 wherein step (c) comprises sending time schedules which indicate free and busy time.

18. The method of claim 17 wherein step (c) comprises run-length encoding the time schedule.

19. The method of claim 18 wherein the free and busy time is represented by a series of bits.

20. The method of claim 17 wherein the time schedules indicate free and busy time segregated into prescribed periods of time.

21. The method of claim 20 wherein the prescribed period of time is five minutes.

22. The method of claim 17 wherein in step (d) a time schedule of the initiator is compared with the time schedules of the other devices and indicates free and busy time.

23. The method of claim 22 wherein step (d) comprises bitwise ANDING the time schedule of the initiator and the time schedules of the respective other devices in order to compare schedules.

24. The method of claim 23 wherein step (d) further comprises generating on the initiator a display which indicates the comparison of free and busy time between the initiator and the devices.

25. The method of claim 16 wherein step (c) comprises sending a time schedule from each of the devices which is read from a respective calendar database of each device.

26. The method of claim 16 wherein step (d) comprises comparing the time schedules of all of the devices with a time schedule of the initiator.

27. The method of claim 16 wherein step (f) comprises agreeing between the initiator and the other devices the time for the appointment by:
i) sending the time for the appointment from the initiator to the other devices;
ii) sending an acceptance response to the initiator from devices which accept the time of the appointment; and
iii) sending a decline response to the initiator from devices which decline the time of the appointment.

28. The method of claim 16 wherein the computing devices are handheld computing devices or desktop computing devices.

29. The method of claim 28 wherein the handheld computing devices are selected from the group consisting of:
PDA's;
Cell Phones; and
Laptop Computers.

30. The method of claim 16 wherein the computing devices communicate over a wireless network or wired network.

31. A system for scheduling appointments between participants wherein one of the participants is designated an initiator of the appointment, the system comprising:
a plurality of computing devices for each participant and in communication with one another without the use of a server; and
collaborative networking software installed on each of the computing devices, the software being configured to:
a) determine with the initiator a time interval for the appointment;
b) send the time interval from the initiator to the devices of the other participants;
c) send a response from the devices to the initiator, each of the responses containing a time schedule of a respective device within the time interval determined by the initiator;
d) compare with the initiator the time schedules from the devices;
e) determine with the initiator a time for the appointment based upon the comparison of the time schedules of the devices; and
f) agree between the initiator and the other devices the time for the appointment.

32. The system of claim 31 wherein the software is configured in step (c) to send time schedules which indicate free and busy time.

33. The system of claim 32 wherein the software is configured in step (c) to run-length encode the time schedule.

34. The system of claim 33 wherein the free and busy time is represented by a series of bits.

35. The system of claim 32 wherein the time schedules indicate free and busy time segregated into prescribed periods of time.

36. The system of claim 35 wherein the prescribed period of time is five minutes.

37. The system of claim 32 wherein the software is configured in step (d) to compare a time schedule of the initiator which indicates free and busy time.

38. The system of claim 37 wherein the software is configured in step (d) to bitwise AND the time schedule of the initiator and the time schedules of the respective other devices in order to compare schedules.

39. The system of claim 38 wherein the software is configured in step (d) to generate on the initiator a display which indicates the comparison of free and busy time between the initiator and the devices.

40. The system of claim 31 wherein the software is configured in step (c) to send a time schedule from each of the devices which is read from a respective calendar database of each device.

41. The system of claim 31 wherein the software is configured in step (d) to compare the time schedules from all of the devices with a time schedule of the initiator.

42. The system of claim 31 wherein the software is configured in step (f) to agree between the initiator and the other devices the time for the appointment by:
i) sending the time for the appointment from the initiator to the other devices;
ii) sending an acceptance response to the initiator from devices which accept the time of the appointment;
iii) sending a decline response to the initiator from devices which decline the time of the appointment; and
iv) sending a confirmation from the initiator to the other device indicating the initiator saved the appointment locally.

43. The system of claim 31 wherein the computing devices are handheld computing devices or desktop computing devices.

44. The system of claim 43 wherein the handheld computing devices are selected from the group consisting of:
PDA's;
Cell Phones; and
Laptop Computers.

45. The system of claim 31 wherein the computing devices communicate over a wireless network or a wired network.

46. A collaborative scheduling software resident on each of a plurality of computing devices in communication with one another, the software being operative to schedule an appointment between the devices wherein one of the devices is designated an initiator of the appointment, the software being configured to perform the steps of:
a) determine a time interval for the appointment with the initiator;
b) send the time interval from the initiator to the devices of the other participants;
c) send a response from the devices to the initiator, each of the responses containing a time schedule of a respective device within the time interval determined by the initiator;
d) compare with the initiator the time schedules from the devices;
e) determine with the initiator a time for the appointment based upon the comparison of the time schedules of the devices; and
f) agree between the initiator and the other devices the time for the appointment.

47. The software of claim 46 wherein the software is configured in step (c) to send time schedules which indicate free and busy time.

48. The software of claim 47 wherein step (c) comprises run-length encoding the time schedule.

49. The software of claim 48 wherein the free and busy time is represented by a series of bits.

50. The software of claim 47 wherein the time schedules indicate free and busy time segregated into prescribed periods of time.

51. The software of claim 50 wherein the prescribed period of time is five minutes.

52. The software of claim 47 configured in step (d) to compare a time schedule of the initiator which indicates free and busy time.

53. The software of claim 52 configured in step (d) to bitwise AND the time schedule of the initiator and the time schedules of the respective other devices in order to compare schedules.

54. The software of claim 53 configured in step (d) to generate on the initiator a display which indicates the comparison of free and busy time between the initiator and the devices.

55. The software of claim 46 configured in step (c) to send a time schedule from each of the devices which is read from a respective calendar database of each device.

56. The software of claim 46 configured in step (d) to compare the time schedules from all of the devices with a time schedule of the initiator.

57. The software of claim 46 configured in step (f) to agree between the initiator and the other devices the time for the appointment by:
i) sending the time for the appointment from the initiator to the other devices;
ii) sending an acceptance response to the initiator from devices which accept the time of the appointment;
iii) sending a decline response to the initiator from devices which decline the time of the appointment; and
iv) sending a confirmation from the initiator to the other devices indicating the initiator saved the appointment locally.

58. The software of claim 46 wherein the computing devices are handheld computing devices or desktop computer devices.

59. The software of claim 58 wherein the handheld computing devices are selected from the group consisting of:
PDA's;
Cell Phones; and
Laptop Computers.

60. The method of claim 46 wherein the computing devices communicate over a wireless network or a wired network.
